(19) United States
(12) Patent Application Publication
(10) Pub. No.: US 2008/0249794 A1
(43) Pub. Date: Oct. 9, 2008

(54) Systems and Methods of Designing, Simulating, Manufacturing and Marketing Tufted Materials

(76) Inventors: John P. Bradford, LaGrange, GA (US); Jeffrey R. Roman, Peachtree City, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/967,450

(22) Filed: Dec. 31, 2007

Related U.S. Application Data
(60) Provisional application No. 60/878,032, filed on Dec. 29, 2006.

(51) Int. Cl. G06Q 30/00

(52) U.S. Cl. 705/1; 703/1

(57) ABSTRACT

Aspects of the invention relate to systems and methods that allow tufted material designers to design within the bounds of what is possible. The invention provides a design tool that bridges the gap between the aesthetic designs or inspiration in the minds of designers and the capabilities of multiple tufting alternatives (e.g., different machines, different setups, etc.). So, for a given desired aesthetic appearance (e.g., a picture of a coconut), a designer can use the design tool to simulate what is possible through various tufting alternatives. In certain embodiments, for a given aesthetic or inspiration, the designer can test what the aesthetic would look like when implemented under the alternative potential configurations. The tool further allows the designer to limit the group of potential configurations by specifically selecting certain constraints (e.g., selecting a particular machine).

### FIELD OF THE INVENTION

The present invention relates generally to computer-related methods and systems for designing, simulating, manufacturing, and marketing carpet and other tufted products.

### BACKGROUND

Tufting machines are used to manufacture carpet and other tufted products. Typically, a tufting machine includes one or more needle bars having needles that tuft yarn loops into a base fabric. The base fabric is moved though the tufting machine with respect to the needle bar or bars, allowing a needle bar to tuft a row of tufts across the fabric, tuft another row after the fabric advances, and so on. Because each needle is usually associated with only one yarn, tufts formed by any given needle are typically formed from the same yarn. Thus, as the base fabric moves along the tufting machine, a given needle creates successive tufts from the same yarn. Many tufting machines can accommodate yarns of different colors, sizes, materials, and other characteristics and can use such differing yarns at the same time (i.e., threaded-up through different needles). Many tufting machines further have the ability to vary the height of the individual tufts, to twist yarns to varying degrees of rotation, to tuft yarns of different tension, to space yarns in varying distances, and to cut, shear, or otherwise modify tufts. These capabilities provide both great flexibility and certain limitations in the patterns and designs that may be created on a given tufting machine.

Tufted products with a variety of appearances are created by selecting individual yarns, selecting an appropriate tufting machine, selecting appropriate tufting machine settings, including pressure foot settings, RPM, and tension in the tufting zone, and appropriate design settings, including pattern and thread up. For certain conventional tufting machines, the pattern is stored on a disk and is used to control pile height pattern, yarn twist, yarn tension, yarn spacing, and yarn finishing (e.g., cut, sheared, etc.). However, in spite of the flexibility available, the appearances that are possible using a tufting machine are limited by the nature of the tufting process and, in many cases, the individual tufting machine capabilities. Carpet designers, who may be at least partially unfamiliar with tufting machine functional details (including the capabilities and settings that may be adjusted), have historically struggled to design carpet within the functional capabilities of tufting machines. Moreover, many would-be-carpet-designers do not enter the field because of their lack of technical understanding. There is a need for improved systems, methods, and tools to allow carpet designers to design within the capabilities of tufting machines and to quickly and efficiently simulate the appearance of a design under alternative configurations and settings. There is a further need for a simulation system that integrates design, manufacturing, and/or marketing capabilities.

### SUMMARY OF THE INVENTION

The present invention relates to systems and methods of designing tufting-machine-produced material. Such methods may involve receiving a desired aesthetic appearance, receiving a user selection corresponding to a tufting machine configuration comprising a tufting machine and tufting machine setup variables, and simulating a simulated tufted appearance of the desired aesthetic appearance as if it were tufted using the tufting machine configuration. The user selection may be of an existing tufted parent product already associated with a tufting machine configuration.

The methods of the invention may involve receiving an electronic image of a desired aesthetic appearance, simulating a first simulated appearance for a first set of tufting variables corresponding to a first tufting machine configuration, and simulating a second simulated appearance for a second set of tufting variables corresponding to a second tufting machine configuration.

The methods of the invention may involve receiving an electronic image of a desired aesthetic appearance or pattern, the image having a resolution and a number of colors, simulating an appearance for a set of variables. This simulation may modify the electronic image by (a) adjusting the number of colors, (b) adjusting the resolution, and (c) selecting a first pattern. Additional appearances for additional sets of variables may be simulated in a similar manner allowing a designer to compare the simulated appearances of a desired aesthetic pattern under alternative tufting conditions, variables, and/or settings.

Certain embodiments involve receiving an electronic image of a desired aesthetic appearance, selecting a parent from a set of two or more potential parents, wherein each parent is associated with one or more settings, and simulating an as-tufted appearance for the desired aesthetic appearance and the parent by (a) modifying the electronic image of the desired aesthetic appearance by adjusting the number of colors to a number appropriate for the parent settings, adjusting the resolution appropriately for the parent settings, and selecting a first pattern appropriate for the parent settings, and (b) using the modified electronic image and the parent settings to generate an image showing the simulated appearance. The method may further involve determining the set of two or more potential parents based on user or automatic selection of one or more constraints.

Certain embodiments provide systems for designing tufting-machine-produced material that involve a central storage area for storing one or more parents associated with settings and accessible by two or more users, a remote device with a simulation interface for simulating an appearance of a desired aesthetic pattern of a material produced on a tufting machine in accordance with the settings of one or more parents retrieved from the central storage area, and a remote device comprising a parent generation interface for a user to generate the settings for one or more parents to be uploaded to the central storage area. The central storage area may further provide storage of color calibration data.

### BRIEF DESCRIPTION OF THE DRAWINGS

These and other features, aspects, and advantages of the present invention are better understood when the following Detailed Description is read with reference to the accompanying drawings, wherein:

FIG. 1 is a system diagram of an exemplary system according to one embodiment of the present invention;

FIG. 2 is an exemplary user interface according to one embodiment of the present invention;

FIG. 3 is a flow diagram of an exemplary method in accordance with one embodiment of the present invention;

FIG. 4 is a flow diagram of an exemplary method in accordance with one embodiment of the present invention; and

FIG. 5 is an exemplary system diagram in accordance with one embodiment of the present invention.

### DETAILED DESCRIPTION

### A. Introduction

The present invention relates to systems and methods that allow tufted-material designers to design within the bounds of what is possible. The invention provides a design tool that bridges the gap between the aesthetic designs or inspiration in the minds of designers and the capabilities of multiple tufting alternatives (e.g., different machines, different setups, etc.). So, for a given desired aesthetic appearance (e.g., a picture of a coconut), a designer can use the design tool to simulate what is possible through various tufting alternatives. This puts a lot of power in the designer's hands—the power to virtually instantaneously get visual feedback of how a given aesthetic can practically be translated into carpet without having to understand the mechanics of the tufting alternatives or their corresponding limitations.

In certain embodiments, for a given aesthetic or inspiration, the designer may apply a “parent,” which is a known machine/setting configuration that already works. A designer can test what the aesthetic would look like when married with a first parent, a second parent, etc. The tool thus provides a designer with the ability to select from a group of potential parents. The tool further allows the designer to limit the group of parents by specifically selecting certain constraints (e.g., selecting a particular machine). On a more global scale, the overall system allows the sharing of parents which in turn provides sharing of known, tried, and/or tested machine capabilities. Use of a large collection of shared parents allows designers (using the design tool) to select the most appropriate parent for a desired aesthetic, and ultimately results, in many cases, in a design that is closer to the desired aesthetic than was previously possible.

### B. Exemplary System

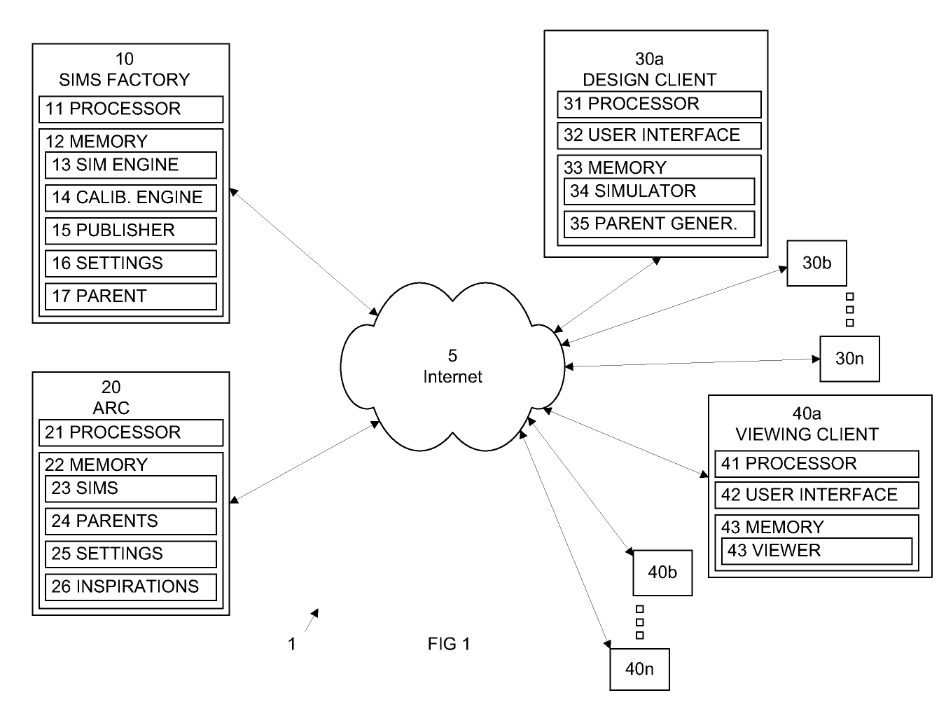

FIG. 1 illustrates a system diagram of an exemplary system according to one embodiment of the present invention. The system 1 is an integrated, computerized system that allows for the design, manufacture, marketing, and sale of carpet tiles. The system 1 has various components that work together utilizing the Internet 5 or other suitable network for communication. The network is not limited to any particular type of network nor is it limited to a single network. For example, the network could be the Internet 5, a LAN, a WAN, a private network, a virtual network, or any combination of network types. Generally, this system 1 includes a sims factory 10, an arc 20, one or more design clients 30a-30n, and one or more viewing clients 40a-40n. Other components and combinations of components are suitable in other embodiments of the invention. Components may be connected to the Internet 1 or other network through any suitable network connection including network, line, or wireless connections, but typically will utilize high speed connection types.

Sims Factory 10 can perform a variety of functions related to the present invention. Generally, it will comprise a computing device that uses any suitable type of processor-based platform and typically will include a processor 11 coupled to a computer-readable medium, such as memory 12. The computer-readable medium can contain program code that can be executed by the processor. A sim engine 13 functions to provide or otherwise generate simulations. A calibration engine 14 functions to calibrate the simulations provided by the sim engine 13. For example, calibration engine 14 may include executable code for a computer program that allows a user to adjust colors so that simulated colors on a computer screen or printout more accurately match the colors of the tufted products intended to be simulated. A publisher 15 component serves to publish or otherwise provide or make available simulations or parents to other components and users on the system 1. A settings 16 component allows a user to adjust settings associated with the sim engine 13 or parent component 17. The parent component 17 may store parent information regarding existing tufted products associated with one or more particular tufting machines and settings.

An ARC database component 20 may be used for storing carpet design files, storing parent configurations and other functions related to the present invention. Generally, it will comprise a computing device that uses any suitable type of processor-based platform and typically will include a processor 21 coupled to a computer-readable medium, such as memory 22. Sims component 23 may store previously provided simulations, e.g., those produced by sim engine 13. Likewise, the parents 24 component may store and make accessible parent information, the settings component 25 may store and make accessible setting information, and the inspirations component 26 may store and make accessible inspiration information. Accordingly, the arc component 20 may generally provide archiving functions, making simulations, parents, settings, and inspirations available to other components and users of the system 1.

One or more design clients 30a-30n may provide design modules that allows a tufted material designer to vary inputs and create new carpet designs, for example, designs based on inspirational images and parent information. In one embodiment, a carpet design is saved as a carpet design file that is then sent to the sim engine 13 to produce a representative image of the carpet design, which is then displayed on the design client 30a. Generally, a design client 30a-30n will comprise a computing device that uses any suitable type of processor-based platform and typically will include a processor 31 coupled to a computer-readable medium, such as memory 32. Applications residing in memory 32 may include a simulator 34, for designing and simulating tufted materials, and a parent generator 34 for generating parent information, e.g., tufting machine type and tufting machine settings for a particular existing tufted product.

One or more viewing clients 40a-40n may perform a variety of functions related to the present invention. For example, an interior designer may use a viewing client 40a to view a simulated product in a simulated or pictured room scene. Generally, a viewing client 40a-40n will comprise a computing device that uses any suitable type of processor-based platform and typically will include a processor 41 coupled to a computer-readable medium, such as memory 43 and a user interface 42. Applications residing in memory 42 may include a viewer 43 for viewing simulated tufted materials.

System 1 may incorporate or otherwise involve other components. For example, a manufacturing system may be used to read design files and produce a tufted product according to the design file. A resource library component may be used for receiving marketing inputs and creating marketing materials. A user interface component may be used for displaying simulations based on design files, receiving orders for the manufacture of tufted materials, and receiving requests for marketing materials. A marketing engine may be used for receiving inputs from user interfaces and other components and for creating marketing reports.

### C. Design

Certain embodiments of the invention facilitate inspiration-based design. Designers begin with inspiration in the form of pictures, ideas, patterns, and other suitable formats, that are submitted, uploaded, or otherwise made available as electronic images. These inspirations are used by a carpet design application to create patterns, which are then used to simulate the as-tufted appearance of the inspiration. The design tool is flexible in that, on the one hand, it can automatically deal with the underlying tufting-machine constraints without the designer having to know of such details and, on the other hand, allows designers to explore variations in tufting settings and configurations without having to understand their details. Designers may specify or hold constant certain variables while modifying others to experiment with potential as-tufted appearances. The designer can modify these variables without needing to understand the underlying machine constraints and settings to which they are linked. However, because the design tool only allows changes to variables associated with feasible underlying tufting machine configurations and settings, it prevents a designer from designing outside of the bounds of what is known to be possible.

Once the designer has selected from among alternative variables, a simulation of the as-tufted appearance of the design under those variables is presented to the designer on a monitor or printer. The designer can then change variables, execute a new simulation, and compare the results of the first simulation with the second simulation. A designer can thus determine the most preferred variables or conditions for turning a given inspiration into a tufted product. Upon final approval, a design, which may be stored as an electronic .sim file, will be uploaded into a database, such as the ARC database 20 of FIG. 1, for future needs. The .sim file may specify a machine type, a particular machine, machine settings, product specifications (e.g., thread up and pattern), and/or yarn use. Thus, the .sim file may be used to estimate the production cost for a given simulation. Such costs can be used by the designer in developing a cost-effective, feasible implementation of a design inspiration that achieves an acceptable as-tufted appearance. In other words, in many cases the design tool allows a designer to balance the competing goals of achieving a level of appearance, achieving within cost constraints, and achieving within what is known to be possible.

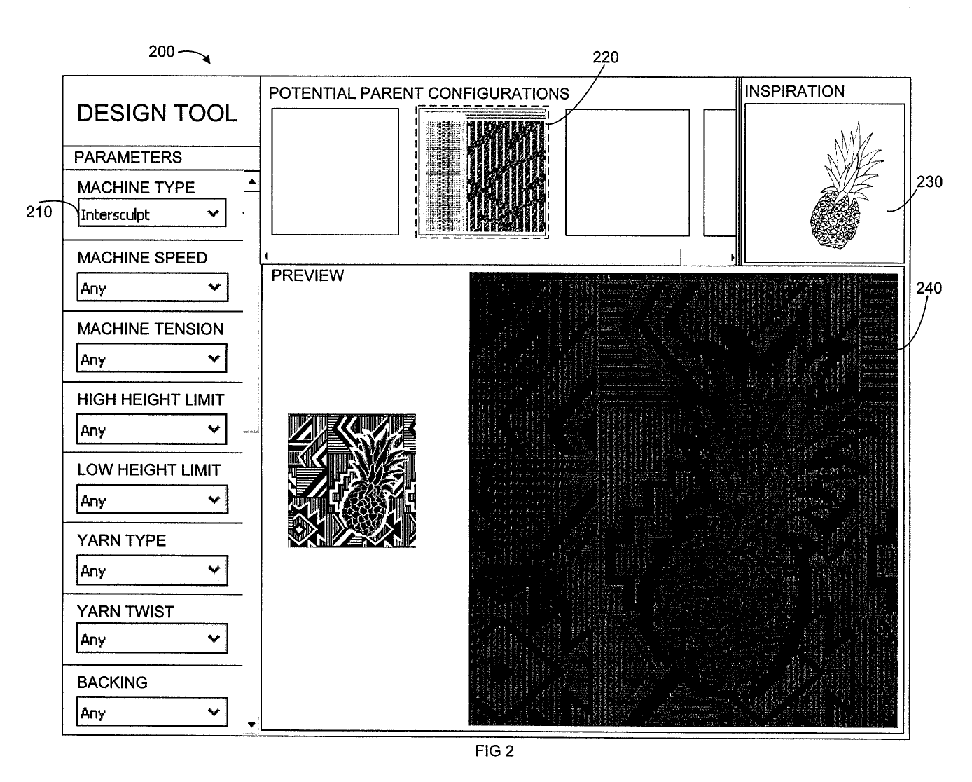

FIG. 2 is an exemplary user interface according to one embodiment of the present invention. A tufted material designer could use this interface as a design tool to create a desired appearance, within cost constraints, and within what is known to be possible. User interface 200 provides space for a user to input and view parameters 210, potential parent configurations 220, and inspiration 230, as well as space for a user to preview a simulated as-tufted appearance of the inspiration under selected parameters and parent configurations.

As described above, a parent is something that is associated with a set of tufting machine settings or parameters. For example, an existing tufting product could be a parent because it is already associated with a particular tufting machine setup and thread-up. However, a parent is not limited to an existing tufted product, and may be any suitable conceptual, graphical, or representative device that relates to or otherwise allows determination of some or all of the tufting machine parameters. The user interface 200 of FIG. 2 may allow a user to import, create, modify, and delete parents as part of a parent design process. Moreover, in terms of designing tufted products, the user interface 200 allows a user to select a parent configuration in space 220.

Upon selection of a parent configuration in space 220, tufting machine parameters (which may include machine type, machine speed, machine tension, high tension limit, low height limit, yarn type, yarn twist, and backing, among other things) are automatically selected in parameter space 210. The user is free to change the parameters using the provided user interface. In certain embodiments, the user is permitted to change parameters to values or selections that are consistent with the remaining settings. Alternatively, in certain embodiments, when a user attempts to change a parameter the user interface identifies other parameters that are necessarily affected by the change. Moreover, the user interface may display an estimated production cost based on the currently selected parameters. Accordingly, a user can “tinker” with the parameters to see the effect on the simulated image while seeing the effect on the estimated production cost.

The user interface 200 may allow creation, input, modification, and/or deletion of an inspiration image in inspiration space 230. The design tool takes the inspiration image and translates it into a simulated image in accordance with the selected parameters 210. This translation may involve a variety of things. For example, certain embodiments involve using the desired aesthetic appearance of the inspiration and the user selection of parameters corresponding to a tufting machine configuration, e.g., a tufting machine and tufting machine setup variables, and simulating a simulated tufted appearance of the desired aesthetic appearance as if it were tufted using the tufting machine configuration. The simulation may be displayed in preview area 240. Changing the parent 220 or parameters 210 allows a user to view a first simulated appearance for a first set of tufting parameters and a second simulated appearance for a second set of tufting parameters. The inspiration may be an electronic image having a resolution and a number of colors. The simulation may modify the electronic image by (a) adjusting the number of colors, (b) adjusting the resolution, and (c) selecting a first pattern.

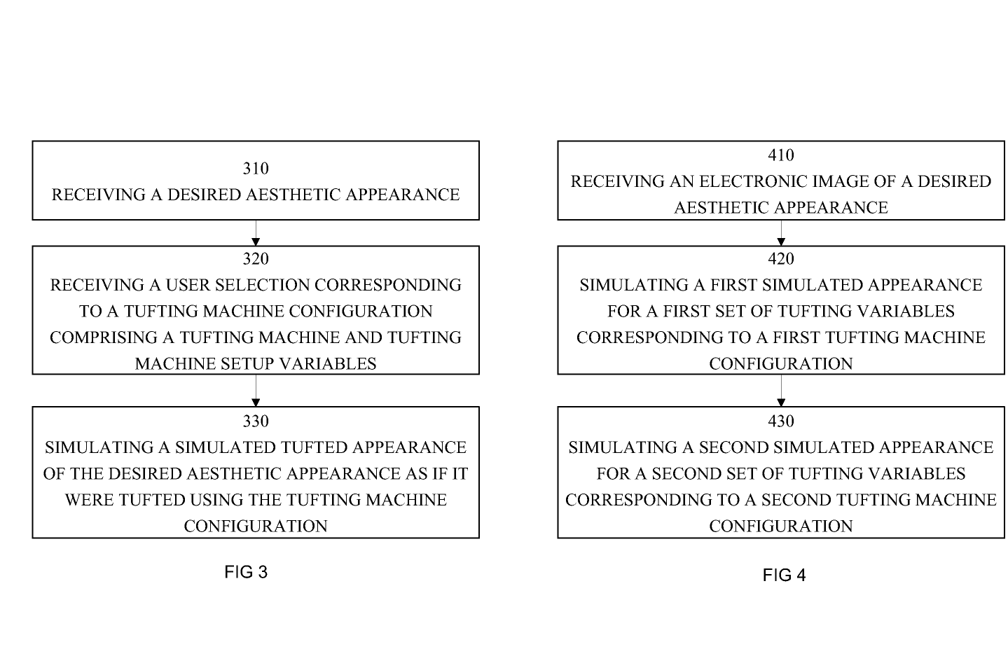

FIG. 3 is a flow diagram of an exemplary method in accordance with one embodiment of the present invention. Such a method may involve receiving a desired aesthetic appearance as shown in block 310. For example, a user could draw an image on a piece of paper, scan the image into an electronic format, and import the image into a computer application. As another example, a user could draw an image using drawing software. As yet another example, a user could use a digital photograph, e.g., of leaves on a forest floor. Any suitable aesthetic appearance (whether graphical, pictorial, CAD image or other representation) may be received. The sources and types of inspiration and aesthetic appearances are virtually unlimited and the invention is not limited in this respect.

The method illustrated in FIG. 3 may further involve receiving a user selection corresponding to a tufting machine configuration comprising a tufting machine and tufting machine setup variables as shown in block 320. For example, these parameters may be selected using a design interface on a computer application. A user may select the parameters as a group or individually, one at a time or all together.

The method illustrated in FIG. 3 may further involve simulating a simulated tufted appearance of the desired aesthetic appearance as if it were tufted using the tufting machine configuration. The user selection may be of an existing tufted parent product already associated with a tufting machine configuration.

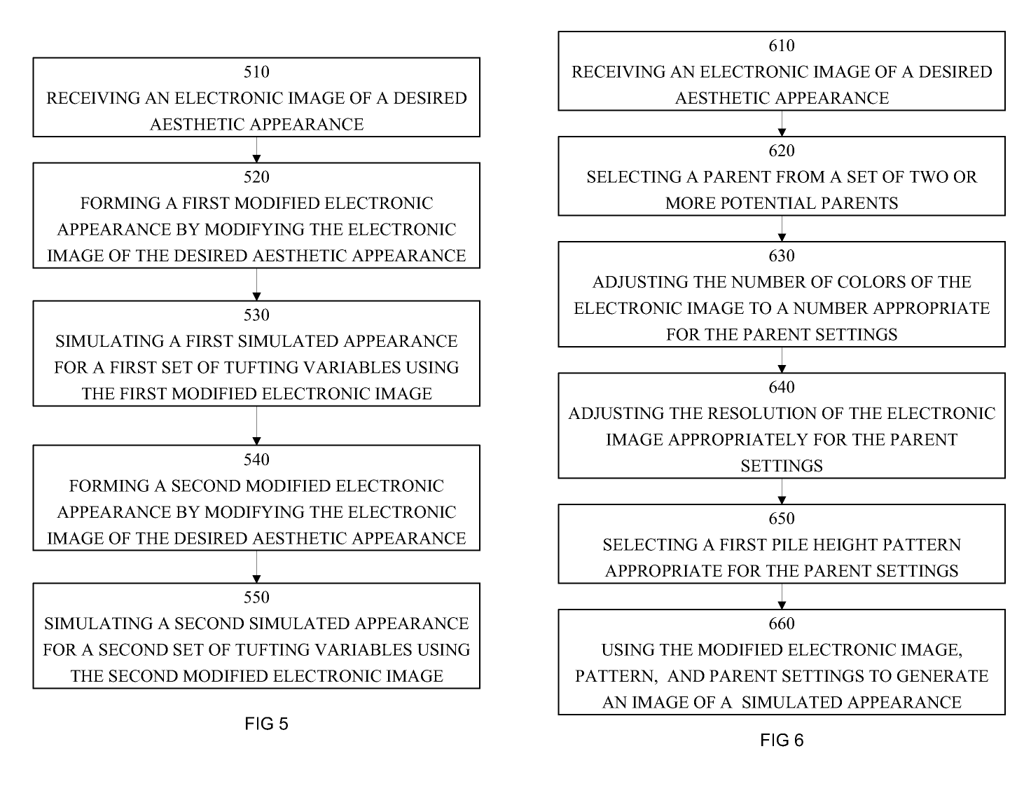

FIG. 4 is a flow diagram of an exemplary method in accordance with one embodiment of the present invention. This method involves receiving an electronic image of a desired aesthetic appearance as depicted in block 410. The electronic image may be in color, black and white, two-dimensional, three-dimension, may include only two colors or up to an unlimited number of colors, and may be or represent a photograph, drawing, sketch, computer generated image, or any other suitable appearance.

The method illustrated in FIG. 4 may further involve, as depicted in block 420, simulating a first simulated appearance for a first set of tufting variables corresponding to a first tufting machine configuration, and, as depicted in block 430, simulating a second simulated appearance for a second set of tufting variables corresponding to a second tufting machine configuration. These simulations may be based on a user's selection of two configurations or may be selected automatically by a software application based on an evaluation of the electronic image. The simulated appearances may be displayed individually or simultaneously to a user on a computer design application.

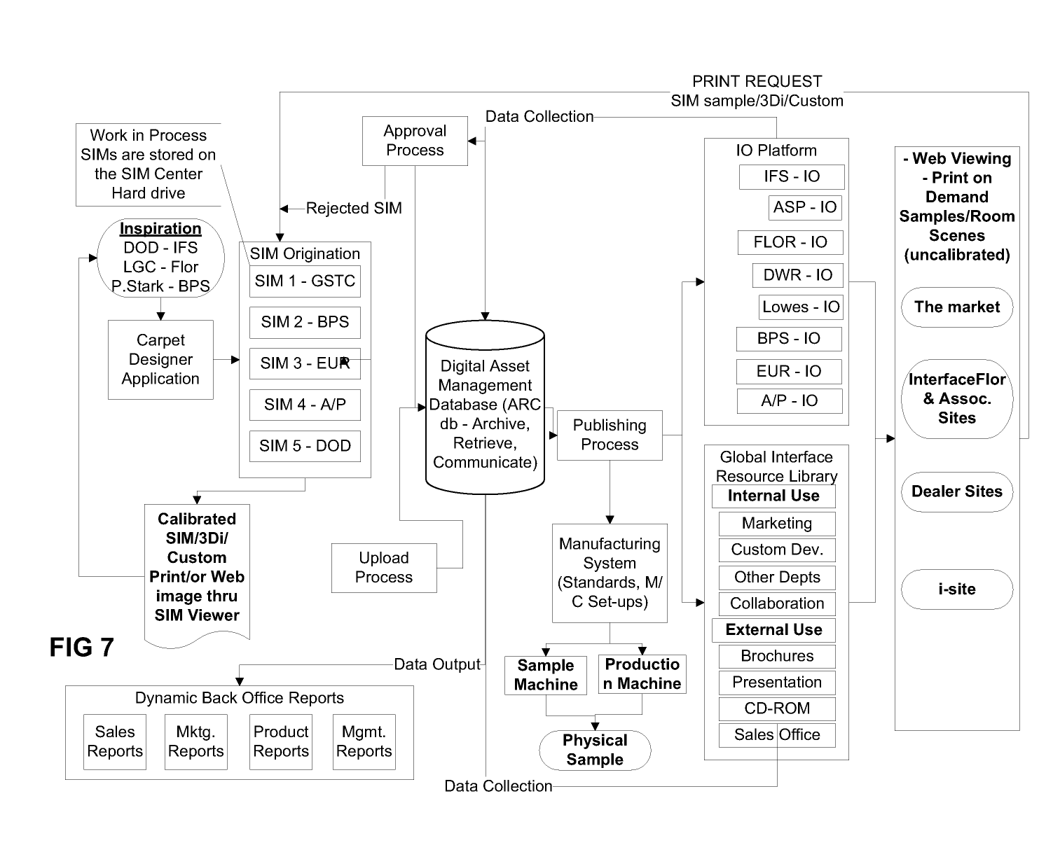

FIG. 5 is a flow diagram of an exemplary method in accordance with one embodiment of the present invention. The method involves receiving an electronic image of a desired aesthetic appearance or pattern, as depicted in block 510. As described above, a desired appearance may be in any suitable format and an image representing a desired aesthetic appearance may have a resolution and a number of colors.

Block 520 depicts forming a first modified electronic appearance by modifying the electronic image of the desired aesthetic appearance. Modifying the electronic image my be accomplished, for example, by (a) adjusting the number of colors, (b) adjusting the resolution, and (c) selecting a first pattern. The modified image may be used to simulate the tufted appearance of the desired aesthetic as depicted in block 530. A second modified electronic image may be formed in a similar manner but based on different parameters, as depicted in block 540, and used to display a simulation of a tufted appearance of the desired aesthetic appearance under the different parameters. Thus, the tufting parameters may be used to determine appropriate adjustments to the number of colors, the resolution, and/or the pattern.

FIG. 6 is a flow diagram of an exemplary method in accordance with one embodiment of the present invention. As with some of the other methods of this invention, this method involves receiving an electronic image of a desired aesthetic appearance, as depicted in block 610. Block 620 depicts selecting a parent from a set of two or more potential parents. Each parent is associated with one or more parameter settings. For example, a parent could be a carpet design for an existing carpet product that is associated with a particular tufting machine type, machine setup, and thread-up.

Blocks 630 and 640 depict adjusting the electronic image based on the parent settings. For example, as depicted, the number of colors and the resolution are adjusted based on the parent settings. Moreover, as depicted in block 650, a pile height pattern is selected that is appropriate for the parent settings. In many cases, the pile height pattern is used to create areas of different colors in the tufted materials that allow the as-tufted end product to resemble the desired appearance.

The modified image may be used as a simulation or otherwise used to create a simulated image of the as-tufted product. Thus, block 660 involves using the modified electronic image, pattern, and parent settings to generate an image of a simulated appearance. In certain embodiments, a user may adjust some or all of the parameters that are associated with a parent. In certain embodiments, a user may manually or automatically blend two or more parents and/or two or more inspirations.

### D. Calibration

In certain embodiments, the system provides color calibration so that the colors appearing on the screen (and ultimately on printed documents) match the actual color of the threads and the as-tufted product. On the global or system-wide scale, this is particularly useful because it provides consistency and improves a designer's ability to accurately match colors. One method of calibrating involves developing a database of feedback on computer color to thread color relationships. For example, for a given design, the machine settings and product specifications, which may be within a .sim file, may be downloaded from the ARC database for use as input to a tufting machine to obtain physical samples. These physical samples are compared to the SIM images and information is recorded in the shared ARC database. Calibrations are noted for future development.

### E. Automated Manufacture

In certain embodiments, an automated manufacturing system can use a carpet design file or .sim file to manufacture carpet with little or no human intervention. This may be accomplished through computer control of both design and manufacturing settings. For example, the appropriate design and manufacturing settings for the tufting machine may be retrieved from a .sim file. This typically involves converting image parameters, such as fuzziness, crispness, etc., to design parameters, such as pattern, thread up, etc. and retrieving manufacturing parameters, such as stitch rate, pile height settings, presser foot settings, tension in tufting zone, rpm, etc. Thus, a sim or other file may include an image that is interpreted to yield these values, an image plus additional fields of information, or simply fields of information from which the design and manufacturing parameters may be derived. Accordingly, one aspect of the present invention involves associating a sim file with design and manufacturing parameters that are automatically or semi-automatically used by a tufting machine. In most cases, a carpet design file or sim file will have all of the data relating to the design setting and manufacturing settings necessary to set up these settings on a tufting machine. The carpet design file can be sent to a tufting machine from the SIM system via a public network, such as the Internet, or a private network/connection and is typically in a format or sent in such a way that will prevent unauthorized manufacture. Accordingly, one aspect of the present invention is a method that involves receiving a carpet design file containing design and manufacturing settings for a tufting machine, automatically setting up the tufting machine with these settings, and manufacturing carpet on the tufting machine.

### F. Marketing, E-Commerce, and Sampling

Another aspect of certain embodiments is the ability to create marketing web content, brochures, and presentations with images of simulated carpet designs. This allows carpet that has never been made to be presented to the consuming public for potential order. This reduces or eliminates the number of actual carpet samples that are needed. In addition, the system may collect and use online feedback to design, modify, and determine the advisability of launching a new product line. After the launch of a product, custom color and other design variations may be requested through an online system. In certain embodiments, the requester may be able to view a simulated version of a given carpet design in custom colors. In certain embodiments, a designer can create or modify designs in response to a custom request by, for example, uploading a standard product from the ARC database, and then modifying various characteristics to determine a cost-effective, feasible design for the custom request. The resulting simulation images can be presented through the web to the custom requester. In addition, the system may track custom requests and the associated images and save relevant information in the ARC database. Such information may be used to make marketing, manufacturing, design, and other decisions and may also be used to generate sample product's or production products in appropriate circumstances.

Simulation images, once created, may be available globally through an online platform of applications and/or websites. The simulated images may be presented or otherwise available in a format that helps protect intellectual property by hiding details regarding the products manufacture and composition. In certain cases, access and control of simulation images is governed using permissions in which images are stored and made available in different resolutions to facilitate viewing in print or web format. The system may also manage version protection and design approval. For example, only simulation images that have gone through an appropriate approval process may be available to certain users. External access to simulation images may be through websites, website applications, phone requests, or other suitable distribution means.

### G. Simulation in a Room Scene

Once simulation images are in the ARC database, they are available to be published to multiple media. The media could include an interactive application that renders simulations of the designs in a room scene. Market segment specific room scenes may be generated for designs geared toward a particular market segment. Tracking and analyzing simulations by segment further provides additional information relevant to a variety of important business considerations including but not limited to adoption of new products and life cycle status of launched products.

### ALTERNATIVE EMBODIMENTS

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Many alternative embodiments are possible without departing from the spirit and scope of the invention.

What is claimed is:

1. A method for designing tufting-machine-produced material comprising:
receiving a desired aesthetic appearance;
receiving a user selection corresponding to a tufting machine configuration comprising a tufting machine and tufting machine setup variables; and
simulating a simulated tufted appearance of the desired aesthetic appearance as if it were tufted using the tufting machine configuration.

2. The method of claim 1, wherein the user selection is of an existing tufted parent product already associated with a tufting machine configuration.

3. A method for designing tufting-machine-produced material comprising:
receiving an electronic image of a desired aesthetic appearance;
simulating a first simulated appearance for a first set of tufting variables corresponding to a first tufting machine configuration; and
simulating a second simulated appearance for a second set of tufting variables corresponding to a second tufting machine configuration.

4. A method for designing tufting-machine-produced material comprising:
receiving an electronic image of a desired aesthetic appearance, wherein the image comprises a resolution and a number of colors;
simulating a first simulated appearance for a first set of tufting variables using a first modified electronic image formed by modifying the electronic image of the desired aesthetic appearance by (a) adjusting the number of colors, (b) adjusting the resolution, and (c) selecting a first pile height pattern; and
simulating a second simulated appearance for a second set of tufting variables using a second modified electronic image formed by modifying the electronic image of the desired aesthetic appearance by (a) adjusting the number of colors, (b) adjusting the resolution, and
(c) selecting a second pile height pattern.
